(19) United States
(12) Patent Application Publication
(10) Pub. No.: US 2006/0156340 A1
(43) Pub. Date: Jul. 13, 2006

(54) Video on demand (VOD) system and method of reconstructing the same

(76) Inventor: Hong-Mook Choi, Metropolitan City (KR)

Correspondence Address: HARNESS, DICKEY & PIERCE, P.L.C., P.O. BOX 8910, RESTON, VA, 20195, US

(21) Appl. No.: 11/328,067

(22) Filed: Jan. 10, 2006

(30) Foreign Application Priority Data
Jan. 11, 2005 (KR) 10-2005-0002464

(51) Int. Cl. H04N 7/173; G06F 3/00; G06F 13/00; H04N 5/445

(52) U.S. Cl. 725/46; 725/87; 725/93; 725/100; 725/131

(57) ABSTRACT

A VOD (video on demand) system in which the replication number of service blocks may depend on the number of instances of an object and service blocks based on access frequencies of the object and service blocks, and a method of reconstructing the VOD system. The VOD system may provide a frequency calculator calculating a frequency of requesting objects and a frequency of requesting service blocks and a controller controlling replication and storing of the objects and the service blocks according to the frequency calculator. The VOD system reconstruction method may include measuring an access frequency of an object and an access frequency of service blocks, comparing disk bandwidth wasted under current conditions with disk bandwidth consumed during system reconstruction, and reconstructing the system based on the comparing results and the measured access frequency of the object and measured access frequency of the service blocks.

### PRIORITY STATEMENT

This application claims the benefit of Korean Patent Application No. 10-2005-0002464, filed on Jan. 11, 2005, in the Korean Intellectual Property Office, the disclosure of which is incorporated herein in its entirety by reference.

### BACKGROUND OF THE INVENTION

1. Field of the Invention

Example embodiments of the present invention relate to a VOD (video on demand) service, and more particularly, a system reconstruction method for efficiently supporting a VOD service provided by a VCR (Video Cassette Recorder) player.

2. Description of the Related Art

As the information/telecommunication technology has developed, VOD (Video On Demand) services have been provided to users for educational applications, teleconferences, electronic libraries, etc. Accordingly, the importance of how a system providing such services processes multiple demands has increased.

A VOD service may include general features, for example, delete, update, insert, search, etc., and/or additional features provided by a VCR (Video Cassette Recorder) player, for example, play, play rewind, fast rewind, fast forward, pause, stop, etc. Objects of the VOD service may include but are not limited to movies, news, soap operas, sports programs, etc.

If a user requests a movie from a VOD manager, the user may watch the movie after an elapsed time. The elapsed time may include an initialization time from the time when a request is sent to the VOD manager to the time when a requested object is read from a system disk, which may be referred to as a startup latency. As the startup latency decreases, the VOD service may more efficiently provide service to a user. Further, a decrease in startup latency may reduce the possibility of the VOD service aborting and/or stalling while an object is transmitted.

FIG. 1 illustrates an example object of a VOD service. Referring to FIG. 1, an object A may include, for example, ten service blocks A1 through A10. For example, if object A is a movie, the entire contents of the ten service blocks A1˜A10 may be sequentially played to show the movie.

FIG. 2 illustrates an example arrangement of system disks and service blocks that may provide the VOD service. Referring to FIG. 2, a system providing the VOD service may include a plurality of disks 210˜230 which may include ten service blocks A1, A2, . . . , A10 constituting the object A shown in FIG. 1. For example, if a user requests to play only the object A, the VOD manager may sequentially provide the first block A1 through the tenth block A10 of the system disks 210˜230 to the user.

A replication technology may be used to reduce the startup latency occurring when a plurality of users request substantially simultaneously the same object, e.g., the same movie, soap opera, sports program, etc. Conventionally, if a plurality of users substantially simultaneously request the same object, a system operator may repeatedly replicate the first block A1 through the tenth block A10 and/or store each of the replicated blocks in system disks 210˜230. For example, the first block A1 through the tenth block A10 may be repeatedly copied and stored in the system disks 210˜230.

Among a variety of object replication methods, a selective replication method may provide an efficient use storage space has been suggested. In this method, each object has a different access frequency. However, this conventional replication method is not efficient in supporting a VCR function.

FIG. 3 illustrates an example arrangement of system disks and replication blocks according to a conventional selective replication method. Referring to FIG. 3, a conventional selective replication may be used to replicate an object and the number of replicated objects may depend on an access frequency of the object. For example, if two replications of the object A are required, twenty service blocks A1˜A10 and A1′˜A1′ are stored in system disks 310˜330.

The conventional selective replication method may only consider the access frequency of the object and does not consider an access frequency of service blocks constituting an object. When only a play function is provided by the VCR player, and various functions, for example, fast forward, fast rewind etc. are not provided by the VCR player, the access frequency of the object will be similar to that of service blocks of the object. However, when functions, for example, fast forward, fast rewind, etc. are provided by the VCR player an access frequency of the object is likely not similar to an access frequency of the service blocks.

### SUMMARY OF THE INVENTION

An example embodiment of the present invention provides a VOD (video on demand) system in which the replication number of service blocks depends on the number of instances of an object and service blocks based on an access frequency for the object and an access frequency of the service blocks.

An example embodiment of the present invention provides a VOD system reconstruction method in which the replication number of service blocks depends on the number of instances of an object and service blocks based on an access frequency for the object and an access frequency of the service blocks.

An example embodiment of the present invention provides A VOD (video on demand) system. The VOD system may include a frequency calculator calculating a frequency of requesting objects and a frequency of requesting service blocks and a controller controlling replication and storing of the objects and the service blocks according to the frequency calculator.

An example embodiment of the present invention provides a source device. The source device may include a system reconstruction device and an access counter calculating a frequency of requesting objects and a frequency of requesting service blocks and transferring the calculated frequencies to a system reconstruction device. The system reconstruction device may control replication and storing of objects and service blocks based on the calculated frequencies.

An example embodiment of the present invention provides a computer program product storing program instructions for execution on a computer system, which when executed by the computer system may cause the computer system to perform a method for requesting data from a VOD system. The method may include generating a request for at least one of an object and service block provided by the VOD system. The request may be organized in accordance with a request format. The request format may include a bit representing service format, a number of bits representing a VCR function, a bit representing RAP information, a bit representing a contents ID, and a plurality of bits representing a device ID.

An example embodiment of the present invention provides a VOD system reconstruction method. The VOD system reconstruction method may include measuring an access frequency of an object and an access frequency of service blocks, comparing disk bandwidth wasted under current conditions with disk bandwidth consumed during system reconstruction, and reconstructing the system based on the comparing results and the measured access frequency of the object and measured access frequency of the service blocks.

An example embodiment of the present invention provides a selective replication method. The selective replication method may include measuring an access frequency of an object and an access frequency of service blocks and replicating a number of objects and service blocks based on the measuring.

### BRIEF DESCRIPTION OF THE DRAWINGS

The present invention will become more apparent by describing in detail example embodiments thereof with reference to the attached drawings.

FIG. 1 illustrates a conventional example of an object of a VOD (Video On Demand) service;

FIG. 2 illustrates a conventional arrangement of system disks and service blocks that may provide the VOD service of FIG. 1;

FIG. 3 illustrates an arrangement of system disks and replication blocks according to a conventional selective replication method;

FIG. 4 illustrates an example embodiment of video clip formats according to an example embodiment of the present invention;

FIG. 5 is a flowchart illustrating a system reconstruction method according to an example embodiment of the present invention;

FIG. 6 is a block diagram illustrating a source device including an illegal replication prevention apparatus according to an example embodiment of the present invention;

FIG. 7 is a block diagram illustrating a sink device including the illegal replication prevention apparatus according to an example embodiment of the present invention;

FIG. 8 is a flowchart illustrating a VOD service according to an example embodiment of the present invention using the source device and the sink device of FIGS. 6 and 7, respectively; and

FIG. 9 illustrates a request format according to an example embodiment of the present invention.

### DETAILED DESCRIPTION OF EXAMPLE EMBODIMENTS

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. 1t should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

As used herein, a video clip may refer to a group of plural video data frames that are separated from a video data stream provided by a VOD manager at the request of a user. Such a separation of the video data stream may satisfy a variety of demands, e.g., accommodating a User when the user does not request the entire video data stream.

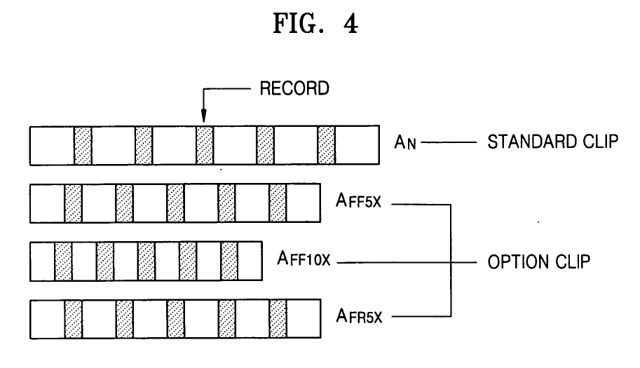

FIG. 4 illustrates example video clip formats. Referring to FIG. 4, a video clip may be divided into a standard clip and one or more option clips.

In the example embodiment of the present invention shown in FIG. 4, a standard clip AN of an object A may indicate a data stream used to play a movie at a normal speed. A user may play the standard clip AN of the object A and watch the movie stored as object A. Option clips AFF5X, AFF10X, and AFR5X of the object A may indicate a data stream equal to various options selected by the user while the movie is being played at a normal speed. For example, the option clip AFF5X may correspond to a five times speed fast forward, the option clip AFF10X may correspond to a ten times speed fast forward, and the option clip AFR5X may correspond to a five times speed fast rewind.

According to an example embodiment of the present invention, if the user requests an option function, for example, fast forward, rewind, etc., while the movie is played at a normal speed using the standard clip AN, a system may convert a transmitted data clip from the standard clip to a requested option clip. That is, a position of the clip being played may correspond to that of a converted clip in view of contents being played and/or an option selected by a user. RAP (Random Access Points) may be inserted in the standard and one or more option clips to enable a conversion. The RAP indicates a position switched from a part of a first clip to a similar part of a second clip.

Referring to FIG. 4, the standard clip and the option clips are arranged at data frame regions (light) and record regions (dark) in turn. Data frame regions may be equal to service blocks including movie data provided. Meanwhile, record regions may be designated by a user in order to apply an RAP concept.

RAP may be mapped according to three operations, for example. First, input values of a VCR function to be provided, for example, the number, speed, direction information, original object, etc., may be determined. Second, a clip may be prepared in which data frames and empty records are arranged. For example, an RAP offset including information on which part of the clip empty records are inserted may be stored, and an ROA (RAP Offset Array) file storing information on the RAP offset may be generated. Third, when the clip is converted into another clip, information on a switching position may be stored in the empty records using the offset information stored in the ROA file and/or a predetermined mapping equation. Information stored in the empty records may be used to find a desired position.

According to an example embodiment of the present invention, to convert a first clip into a second clip, a PM (Presentation Manager) in charge of a user's VCR request and/or corresponding mapping information may be used.

For example, if a user requests a VCR function while a standard clip is being displayed, the PM may confirm RAP position exchange information on record regions and convert displayed data to frame regions of an option clip corresponding to frame regions of the standard clip. Further, if a user requests the displayed option clip to be converted to the standard clip again, the PM may confirm RAP position exchange information on record regions and convert the displayed option clip back to the standard clip.

According to an example embodiment of the present invention, a PM may insert RAP mapping into original data to support a VCR function, confirm an option clip generating process and/or RAP position exchange information, and convert a first clip to a second clip.

An access frequency of each service block constituting a standard clip may be substantially constant. However, because a user may choose not use an option clip for all service blocks of an object, an access frequency in the option clip may differ from service block to service block.

According to an example embodiment of the present invention, a number of replicated service blocks may differ according to an access frequency of each service block of the same object, thereby providing a reduced amount of wasted disk bandwidth.

For example, a five times fast forward play clip AFF5X may include ten service blocks AFF5X0˜AFF5X9. A user scarcely requests every VCR function of all the ten service blocks. According to an example embodiment of the present invention, when an access frequency of a third service block AFF5X2 is high and an access frequency of a first service block AFF5X0 is low, the third service block AFF5X2 may be replicated more than the first service block AFF5X0.

Based on access frequencies of N number of objects and a plurality of service blocks constituting each object, the number of instances of each object and the number of instances of each service block may be determined according to an example embodiment of the present invention.

According to an example embodiment of the present invention, a system providing a VOD service may replicate objects and service blocks according to a number of instances and store the replicated objects and service blocks in a system disk. Since a user's VOD request may not have a fixed pattern, the instance number may be re-determined, if necessary, and the re-determined instance number may be reflected in the system. An instance number may be based on a frequency of requesting objects and/or a frequency of requesting service blocks of one or more objects. An instance number may be predetermined during an initial system construction and/or changed during a system reconstruction. Further, a system reconstruction may be based on a change in a frequency of requesting objects and/or a frequency of requesting service blocks.

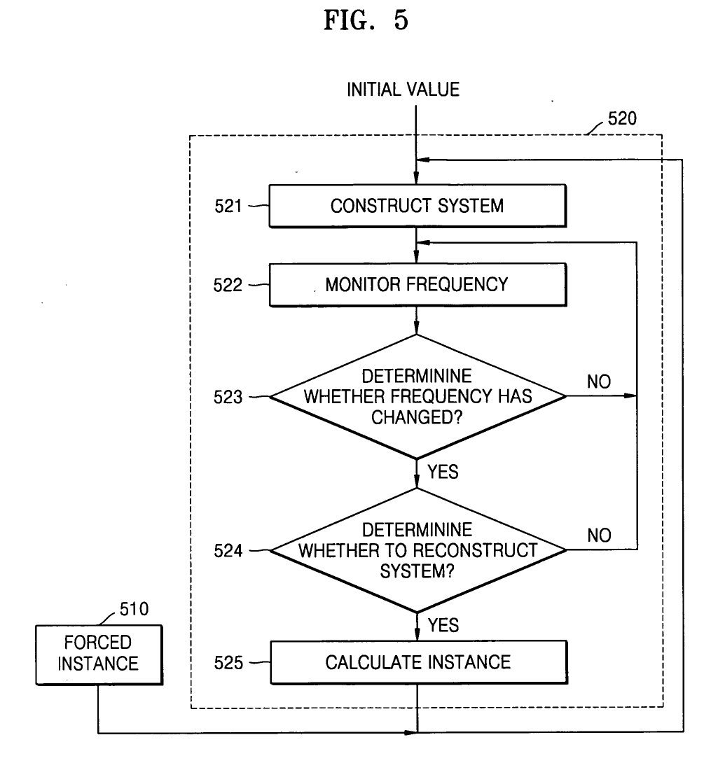

FIG. 5 is an example flowchart illustrating a system reconstruction method according to an example embodiment of the present invention. Referring to FIG. 5, according to a forced system reconstruction (Operation 510), a new instance may be input in a system based on statistics and/or experience regarding one or more users' requests. For example, a user and/or manager may trigger a forced system reconstruction.

An example embodiment of the system reconstruction may also include a planned system reconstruction (Operation 520). A system reconstruction may be planned based on a specified time and/or specified event, for example, routine updates, system failure, power outages, etc. For example, an initialization value may be established, an access frequency of an object and service blocks requested by one or more users may be measured, an advantage obtained by applying the measured access frequency may be compared with an overhead for the system reconstruction, and a process advantageous to a system operation may be selected based on the comparison. An example of a comparison may compare disk bandwidth wasted under the current system construction with the disk bandwidth used during the system reconstruction and expected disk bandwidth used after a system reconstruction.

The planned system reconstruction (Operation 520) may comprise constructing a system (Operation 521), monitoring a frequency of requesting objects and/or a frequency of requesting service blocks (Operation 522), determining whether one or more of the frequencies has changed (Operation 523), determining whether to reconstruct the system (Operation 524), and calculating an instance corresponding to when the system reconstruction should be performed (Operation 525).

In an example Operation 521, a frequency for one or more objects and a frequency for the service blocks of the one or more objects may be established as an initialization value input and the system may be reconstructed according to the initialization value input. The initial value may be determined according to a statistical analysis and/or one or more users' experience.

In an example Operation 522, a frequency for a plurality of objects requested by the user and a frequency of service requests for a plurality of service blocks constituting each object may be monitored. For example, a counter may be used to count and/or store how many time a specific object and/or service block is requested by one or more users.

In an example Operation 523, a monitored frequency for objects and/or service blocks may be compared with an established frequency (e.g., preset frequency) to determine whether the frequency has changed. For example, if it is determined that the frequency has not changed, Operation 522 may be performed until it is determined that the frequency has changed.

In an example Operation 524, if it is determined that the frequency has changed, whether to reconstruct the system may be determined based on improvements in a system performance obtained by reconstructing the system according to the changed frequency and a disk bandwidth wasted by overhead used in reconstructing the system. For example, when the Operation 524 determines it is more efficient to maintain a present system configuration, Operations 522 and 523 may be performed and/or repeated until it is determined that the frequency changes and/or it is best to reconstruct the system.

In an example Operation 525, when it is determined by the Operation 524 that a system reconstruction is beneficial, a new instance of objects and/or service blocks is calculated and the calculated instance is provided to Operation 521.

An example embodiment of a method according to the present invention may be represented by the following, wherein A denotes an object, R(A) denotes a number of service blocks included in an object, B denotes a service block included in an object A, N denotes an upper limit, F denotes an access frequency corresponding to object A, f denotes an access frequency corresponding to the service blocks of object A, P denotes expected improvement resulting from a system reconfiguration, and W denotes disk bandwidth used during a system reconstruction.

```
Step 1: Information of initial access frequencies
Step 2: for (0 ≦ A < N)
        F is access frequency corresponding to A
        for (0 ≦ B < R(A))
            f is access frequency corresponding to B
Step 3: Calculate # of instances (A, B)
Step 4: Determine data placement
Step 5: if(changes in access frequency)
        Go to 6
      else(no changes in access frequency)
        Move initial stage of step 5
Step 6: if(P ≧W)
        Go to step 7
      else(P < W)
        Return to step 5
Step 7: Calculate new access frequency (F, f)
    Output F, f (calculated access frequencies)
    Return to step 2
* Forced reconfiguration → Go to step 7
```

Periodically reconstructing an instance number of an object and rearranging object data according to an access frequency may improve and/or optimize system performance. As illustrated above, an example embodiment of a system reconstruction may undergo seven operations.

In an example Step 1, because it may be difficult and/or impossible to accurately predict an access frequency of an object, the access frequency may be provided to a manager according to a popularity prediction of the object A.

In an example Step 2, information necessary for reconstructing the system, i.e., an access frequency F of the object A and an access frequency f of each service block of the object A, may be obtained.

In an example Step 3, an optimum instance number of the object A may be determined using the access frequency F of the object A obtained in the Step 2. A determined instance number X of the object A may be based on a determination of an initial instance number of each service block of the object A. After an initial system construction operation, an instance number and an access frequency f of each service block may be determined by a value f that is provided to Step 2 by Step 7. A value F of Step 2 may be used in the initial system construction.

In an example Step 4, the instance number of the object A determined in Step 3 may be used to arrange data in a contents storage device, for example.

In an example Step 5, the access frequencies F and f of the object A and each service block, respectively, may be monitored. For example, if it is determined that access frequencies F and/or f have changed, a system reconstruction method according an example embodiment of the present invention may be performed.

In an example Step 6, a system reconstruction determination operation may be performed to determine whether to reconstruct the system based on improvements P in system performance obtained by reconstructing the system and a disk bandwidth W wasted by an overhead used reconstructing the system. For example, if a determination is made to reconstruct the system, Step 7 may be performed, otherwise Steps 5 and/or 6 may be repeated.

In an example Step 7, new access frequencies F and f may be calculated according to a forced reconstruction and calculated access frequencies may be provided to Step 2.

According to an example embodiment of a method according to the present invention, one or more of Steps 1-7 may be periodically repeated. For example, when a manager adds a new object and/or deletes an existing object, even though an existing access frequency may not change, Step 7 may be performed. In a mapping, the PM may calculate an access frequency of a service block when a user uses a VCR function.

It should be understood that Steps 1-7 described above are merely illustrative and not meant to limit the present invention. For example, one or more of Steps 1-7 may be rearranged or removed from the example embodiment of a method according to the present invention.

A selective replication method of reconstructing a system by determining an instance number of an object and service block and/or arranging data according to the access frequency of the object and service block according to an example embodiment of the present invention efficiently supports the VCR function. The method according to an example embodiment of the present invention may result in efficiently using storage space and reducing startup latency and/or stalling.

An example embodiment of the present invention may also prevent illegal replication in addition to possibly improving and/or optimizing system performance and providing high quality service. Accordingly, an example embodiment of the present invention may also provide a source device and/or a sink device. A source device according to an example embodiment of the present invention may represent a server of a VOD service manager and a sink device according to an example embodiment of the present invention may represent a device for receiving data from the VOD service manager and playing the received data.

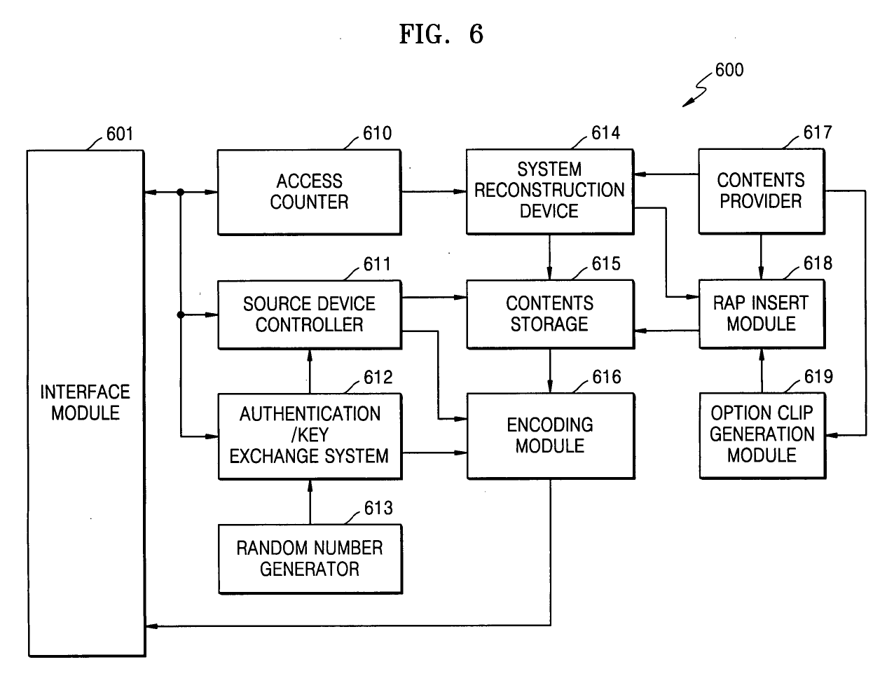

FIG. 6 is an example block diagram illustrating a source device according to an example embodiment of the present invention including an illegal replication prevention apparatus. Referring to FIG. 6, a source device 600 may comprise an access counter 610, a source device controller 611, an authentication/key exchange system 612, a random number generator 613, a system reconstruction device 614, a contents storage device 615, an encoding module 616, a contents provider 617, an RAP insert module 618, and an option clip generation module 619.

According to an example embodiment of the present invention, an interface module 601 may interface a user requesting service with a sink device 700. An interface module 601 may use interfaces, for example, LAN (Local Area Network), IEE 1394, etc.

According to an example embodiment of the present invention, an access counter 610 may check an access frequency of one or more objects and an access frequency of one or more service blocks in a selective replication. For example, if a user requests service for the object and/or the service block, the access counter 610 may check a frequency of requests and transfer the checked frequency to a system reconstruction device 614.

According to an example embodiment of the present invention, a source device controller 611 may control an illegal replication prevention apparatus of a source device 600. For example, if a sink device requests contents service, the source device controller 611 may receive a result of an authentication of the sink device from an authentication/key exchange system 612. 1f the sink device is authenticated by an authentication/key exchange system 612, the source device controller 611 may command a contents storage 615 to transmit stored data to an encoding module 616. Further, for example, if a sink device is not authenticated by the authentication/key exchange system 612, the source device controller 611 may cancel a content request from the sink device. The source device controller 611 may manage encoding from start to end and transmit a signal to the encoding module 616. The signal may be used to transmit finally encoded contents received from the contents storage device 615 to the sink device.

According to an example embodiment of the present invention, an authentication/key exchange system 612 may authenticate a sink device and exchange keys according to an authentication/key exchange protocol. Further, if the sink device is authenticated, the authentication/key exchange system 612 may provide an authentication result to the source device controller 611, as well as an encoding algorithm selection signal, which may be used for authentication and contents encoding. An authentication/key exchange system 612 may also transmit a key used for encoding to an encoding module 616.

According to an example embodiment of the present invention, a random number generator 613 may generate a random number used to authenticate and and/or decode coded contents in an authentication/key exchange system 612.

According to an example embodiment of the present invention, a system reconstruction device 614 may reconstruct a system according to a system reconstruction algorithm and receive a value of an access frequency of an object and/or an access frequency of a service block used for the system reconstruction from the access counter 610 and/or initial construction information from a contents provider 617. The initial construction information may include a value of the access frequency predicted by a contents provider 617. A predicted value may be based on an initial system construction. For example, when an object is updated, such initial construction information may be provided to the system reconstruction device 614 from the contents provider 617. A system reconstruction device 614 may receive information on the access frequency from the access counter 610 and/or the initial construction information from the contents provider 617, reconstruct the system according to a system reconstruction algorithm, and transfer the reconstruction result to an RAP insert module 618.

According to an example embodiment of the present invention, a contents storage device 615 may receive the system reconstruction information from the system reconstruction device 614 and store contents including original data, arrangement information, RAP information, etc. A contents storage device 615 may receive a resultant value according to the system reconstruction algorithm from a system reconstruction device 614, and store ‘data’ based on a resultant value received from an RAP insert module 618. A contents storage device 615 may also transmit stored data and/or contents to an encoding module 616.

According to an example embodiment of the present invention, an encoding module 616 may encode the contents received from the contents storage device 615. The encoding module 616 may use a key received from an authentication/key exchange system 612 and a selected encoding algorithm.

According to an example embodiment of the present invention, a contents provider 617 may provide initial construction information to the system reconstruction device 614 and/or original data to a RAP insert module 618 and the option clip generation module 619. The content provider 617 may also update new contents.

According to an example embodiment of the present invention, an RAP insert module 618 may insert RAPs in original data, (e.g., one time speed contents) received from the contents provider 617 and in fast forward/rewind data generated from an option clip generation module 619. An RAP insert module 618 may also provide data with the RAP inserted contents to the contents storage device 615 according to a determination of the system reconstruction apparatus 614.

According to an example embodiment of the present invention, an option clip generation module 619 may generate one or more option clips capable of VCR functions (e.g., fast forward/rewind functions) using original data, which may be received from a contents provider 617 and may transmit the generated one or more option clips to the RAP insert module 618.

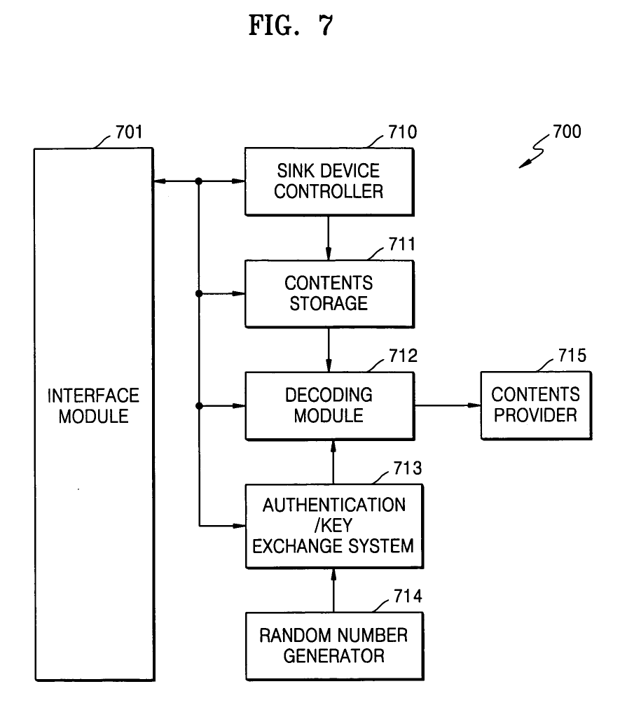

FIG. 7 is a block diagram illustrating a sink device including an illegal replication prevention apparatus according to an example embodiment of the present invention. Referring to FIG. 7, the sink device 700 may comprise a sink device controller 710, a contents storage 711, a decoding module 712, an authentication/key exchange system 713, and a random number generator 714.

According to an example embodiment of the present invention, an interface module 701 may interface a user requesting service with the source device 600. The interface module 701 may use interfaces, for example, the LAN, IEE 1394, etc.

According to an example embodiment of the present invention, a sink device controller 710 may control the illegal replication prevention apparatus of the sink device 700, transfer a contents request to a source device 600, and receive an authentication result of the source device 600 from the authentication/key exchange system 713.

According to an example embodiment of the present invention, if a source device 600 is authenticated, the sink device controller 710 may command a contents storage device 711 to transfer encoded contents received from a source device 600 to a decoding module 712 when a user requests contents to be transmitted in real time. Further, if the user requests to store contents in a user's storage, the sink device controller 710 may command a contents storage device 711 to store the encoded contents. A sink device controller 710 may manage decoding performed by the decoding module 712 from start to end and transmit a signal to a decoding module 712. The signal may be used to transmit decoded contents received from the contents storage 711 to a specified destination.

According to an example embodiment of the present invention, the contents storage device 711 may receive a command to store the contents encoded from the illegal replication prevention apparatus of the source device 600 from a sink device controller 710 and store the encoded contents. In this case, a user does not request contents to be transmitted in real time but requests contents to store the encoded contents in a user's storage device. 1f the sink device controller 710 commands the contents storage 711 to transfer the encoded contents to the decoding module 712, the contents storage 711 may transfer the encoded contents received from the source device 600 to a decoding module 712.

According to an example embodiment of the present invention, the decoding module 712 may decode contents received from the contents storage 711 and/or the encoded contents received from a source device 600 using a key received from an authentication/key exchange system 612 and a selected encoding algorithm. A decoding module may be controlled by a sink device controller 710.

According to an example embodiment of the present invention, an authentication/key exchange system 713 may authenticate a source device 600 and exchange keys according to an authentication/key exchange protocol. 1f a source device 600 is authenticated, the authentication/key exchange system 612 may exchange an authentication result. An encoding algorithm selection signal may be used to authenticate and/or decode contents, and a key used to decode contents may be transferred to a decoding module 712.

According to an ‘example embodiment of the present invention, a random number generator 714 may generate a random number used to authenticate and encode contents in the authentication/key exchange system 713.

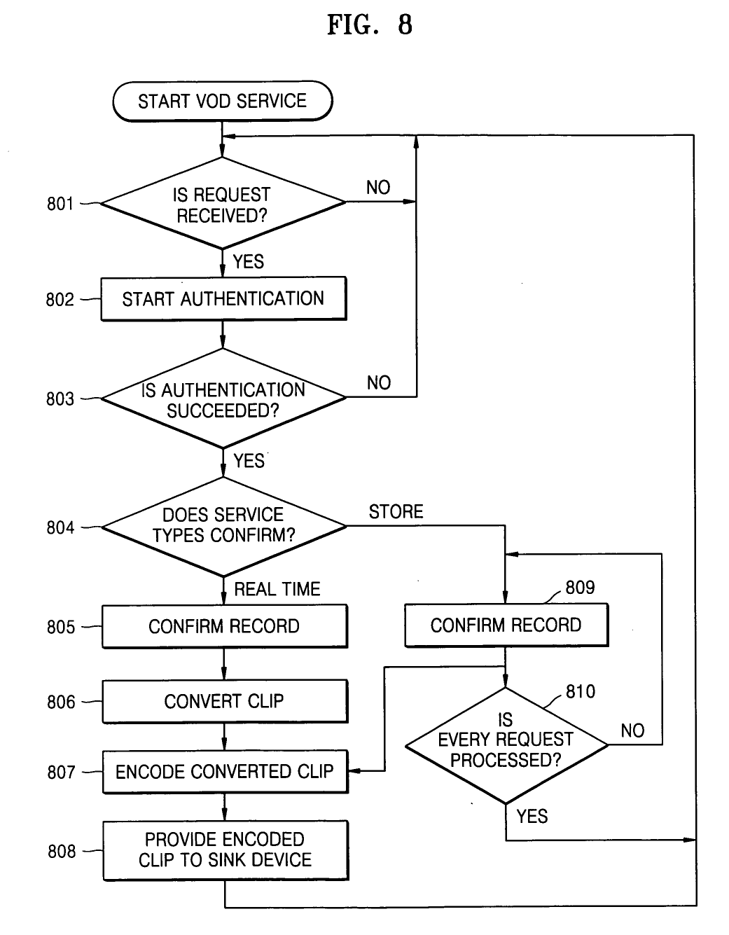

FIG. 8 is a flowchart illustrating a VOD service using a source device and a sink device according to an example embodiment of the present invention. Referring to FIG. 8, if a user requests contents (Operation 801), an authentication of the sink device may start using an 1D of the sink device and/or a random number (Operation 802). The sink device may authenticate the source device. The authentication of the sink device and an authentication of the source device may differ according to the VOD service. Mutual authentication may be used for increased security.

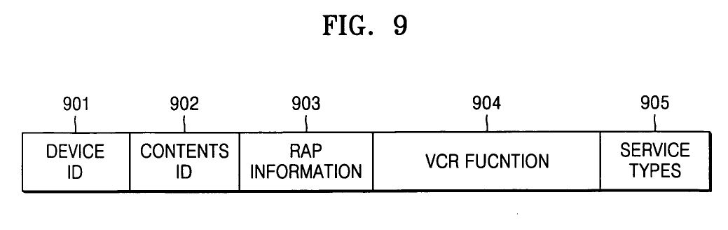

According to an example embodiment of the present invention, if the authentication fails, a next request may stand by. 1f the authentication succeeds, a requested service format may be confirmed (Operation 803). 1f a confirmed service format is real time service (Operation 804), a record may be confirmed (Operation 805). For example, a desired VCR function and a play position may be confirmed using a request format shown in FIG. 9, for example. 1f such a confirmation is completed, a PM may convert a clip presently played to another clip (Operation 806). For example, if a user requests a five time speed forward while watching original contents, a currently watched clip may be converted to a five times forward option clip and an RAP may be confirmed. The converted option clip may be encoded (Operation 807) and provided to the sink device (Operation 808).

Further, according to an example embodiment of the present invention, if a confirmed service format corresponds to a storing service (Operation 804), a VCR function desired by the user may be confirmed. The user may select one or several of a plurality of VCR functions. 1f the user selects several functions at one time, a sink device controller may sequentially request desired data including original data. RAP may be inserted in original data to support one or more VCR functions. The RAP may be 0 in a storing service. According to an example embodiment of the present invention, the original data may be first encoded (Operation 807) and provided to the sink device (Operation 808). Data equal to other VCR functions desired by the user may be encoded (Operation 807) and provided to the sink device (Operation 808). 1f all the desired requests are sequentially processed (Operation 809), a next request stands by (Operation 810).

FIG. 9 illustrates a request format according to an example embodiment of the present invention. Referring to FIG. 9, a request format may include a device ID 901, a contents ID 902, RAP information 903, a VCR function 904, and service formats 905.

According to an example embodiment of the present invention, a bit representing the service formats 905 may be an LSB (Least Significant Bit) and indicate whether a user requests a real time service or a storing service. For example, 0 may indicate real time service and 1 may indicate a storing service. A sink device processing method may differ according to the service formats 905.

According to an example embodiment of the present invention, a number of bits representing the VCR function 904 may be 1 when the source device supports one VCR function and 2 when the source device supports two VCR functions, etc. The bit number may differ according to a supported VCR function. For example, if the source device supports four VCR functions, for example, a first bit FF1X (first time speed forward, e.g., original contents), a second bit FF3X (e.g., three times speed forward), a third bit FR3X (e.g., three times speed rewind), and a fourth bit FF5X (e.g., five times speed forward), the bit number representing the VCR function may be 4. Bits representing the VCR function may all be 0 when there is no user request and a bit representing the VCR function requested by the user is 1. For example, if the user requests a three times speed function, a second bit representing the VCR function may be 1.

According to an example embodiment of the present invention, a user may request one VCR function in the real time service, whereas, the user may request several VCR functions in a storing service. When a user requests the VCR function in order to see the stored contents, the user may request data equal to VCR functions other than the original contents. In this case, data equal to the desired VCR functions may be sequentially processed.

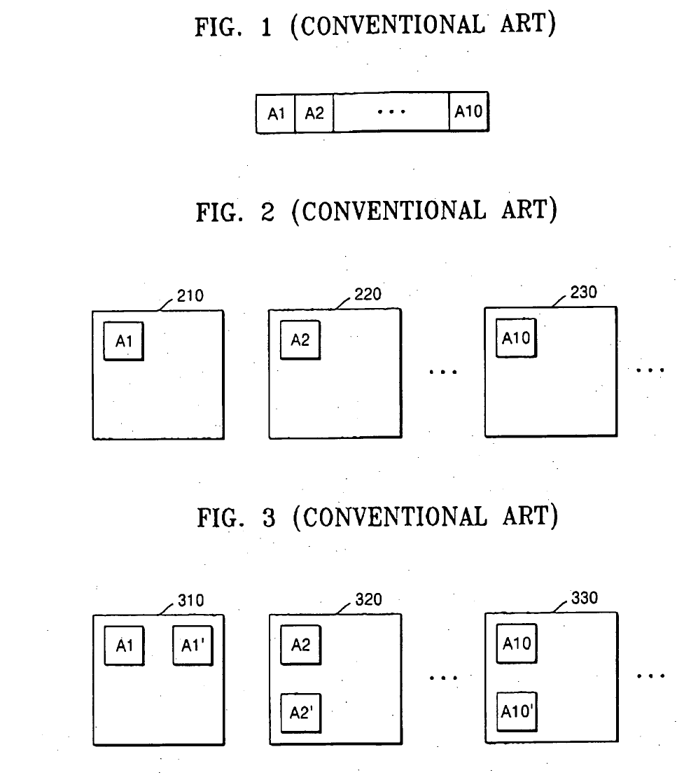

According to an example embodiment of the present invention, a bit representing RAP information 903 may be used for clip conversion. In a real time service, a user may request a VCR function while watching original data. In this case, as described with reference to FIG. 1, the PM may confirm a record and search for an RAP. In particular, a play position may be confirmed and a clip may switch to a corresponding position in an option clip. If the VCR function is selected, an option clip may be accessed. If RAP information is established, a play position desired by the user is confirmed. In the storing service; an RAP position is 0 (except for the succession) and the whole data may be stored.

According to an example embodiment of the present invention, a bit representing the contents ID 902 may include information on contents desired by the user, e.g., an ID of a movie desired by the user. For example, if a user desires a movie A and an ID of the movie A is 3, two bits may be necessary and a logical value of two bits of 11 may be established as a contents ID. The contents ID may differ according to the amount of contents supported by the source device.

According to an example embodiment of the present invention, a bit representing the device ID 901 may indicate an intrinsic ID of the sink device. The ID may be used for an authentication of the sink device.

According to an example embodiment of the present invention, when a device supporting and/or requesting VOD service is prepared, VOD service may start. A user may request a source device for a desired service through a 'sink device. A source device may stand by until a request is made.

Although described primarily in terms of hardware above, the example methodology implemented by one or more components of the example system described above may also be embodied in software as a computer program. For example, a program in accordance with the example embodiments of the present invention may be a computer program product causing a computer to execute a VOD system reconstruction method and/or a method for requesting data from a source device according to an example embodiment of the present invention.

The computer program product may include a computer-readable medium having computer program logic or code portions embodied thereon for enabling a processor of the system to perform one or more functions in accordance with the example methodology described above. The computer program logic may thus cause the processor to perform the example method, or one or more functions of the example method described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAM, ROM, flash memories and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal embodied in a carrier wave. The computer data signal embodying one or more instructions or functions of the example methodology may be carried on a carrier wave for transmission and/or reception by an entity that executes the instructions or functions of the example methodology. For example, the functions or instructions of the example method may be implemented by processing one or more code segments of the carrier wave in a computer controlling one or more of the components of example embodiments of the present invention described above, where instructions and/or functions may be executed.

Further, such programs, when recorded on computer-readable storage media, may be readily stored and distributed. The storage medium, as it is read by a computer, may enable the processing of multimedia data signals prevention of copying these signals, allocation of multimedia data signals within an apparatus configured to process the signals, and/or the reduction of communication overhead in an apparatus configured to process multiple multimedia data signals, in accordance with the example method described herein. For example, a computer program product storing program instructions for execution on a computer system, which when executed by the computer system may cause the computer system to generate a request for one or more objects and/or one or more service blocks of a VOD system. The request may be organized in accordance with a request format as described above with respect to an example embodiment of the present invention illustrated in FIG. 9.

According to an example embodiment of the present invention, the VOD system and the VOD system reconstruction method may reduce startup latency in a general play, startup latency in a VCR function play, stalling, and may more efficiently use storage space. Further, according to an example embodiment of the present invention, information may be provided only to an authorized user, encoded data may be transmitted, and the transmitted contents may be decoded by the authorized user, thereby improving content security.

While this invention has been particularly shown and described with reference to example embodiments thereof, it will be understood by those skilled in the art that various changes in form and details may be made therein without departing from the scope of the invention.

What is claimed is:

1. A VOD (video on demand) system comprising:
a frequency calculator calculating a frequency of requesting objects and a frequency of requesting service blocks; and
a controller controlling replication and storing of the objects and the service blocks according to the frequency calculator.

2. The VOD system of claim 1, wherein the controller determines a number of replicated objects based on the frequency of requesting the objects and determines a number of the replicated service blocks based on the determined number of the replicated objects and the frequency of requesting the service blocks.

3. The VOD system of claim 1, further comprising:
a system disk including at least one disk and storing the replicated objects and the replicated service blocks.

4. A source device, comprising:
a system reconstruction device; and
an access counter calculating a frequency of requesting objects and a frequency of requesting service blocks and transferring the calculated frequencies to a system reconstruction device, wherein
the system reconstruction device controls replication and storing of objects and service blocks based on the calculated frequencies.

5. The source device of claim 4, wherein a number of the replicated objects is determined according to the frequency of requesting the objects; and
a number of the replicated service blocks is determined according to the determined number of the replicated objects and the frequency of requesting the service blocks.

6. The source device of claim 4, further comprising:
a random number generator generating a random number used for authentication and contents encoding; and
an authentication/key exchange device’ authenticating a sink device and generating an authentication result and an encoding algorithm selection signal used for authentication and contents encoding.

7. The source device of claim 6, further comprising:
a contents storage device receiving system reconstruction information from the system reconstruction device and storing data including random access points (RAP).

8. The source device of claim 7, further comprising:
an encoding module encoding the contents received from the contents storage device based on a key received from the authentication/key exchange device and the encoding algorithm selection signal.

9. The source device of claim 8, further comprising:
a source device controller commanding a transmission of stored data from the contents storage device to the encoding module when the sink device is authenticated.

10. The source device of claim 7, further comprising:
a contents provider providing initial construction information to the system reconstruction device and original data to the source device.

11. The source device of claim 10, further comprising:
an option clip generation module generating at least one option clip based on the original data and a VCR function.

12. The source device of claim 11, further comprising:
an RAP insert module inserting RAPs into at least one of the original data and the at least one option clip and providing the RAP inserted content to the content storage device based on information from the system reconstruction device.

13. A computer program product storing program instructions for execution on a computer system, which when executed by the computer system causes the computer system to perform a method for requesting data from a VOD system, the method comprising:
generating a request for at least one of an object and service block provided by the VOD system.

14. The computer program product of claim 13, wherein the generating includes:
organizing a request such that the request includes a bit representing service format, a number of bits representing a VCR function, a bit representing RAP information, a bit representing a contents ID, and a plurality of bits representing a device ID.

15. The computer program product of claim 14, wherein the bit representing service format is a LSB (Least Significant Bit) and indicates whether a user requests real time service or storing service.

16. The computer program product of claim 15, wherein, in the bit representing service format, 0 indicates a real time service and 1 indicates a storing service.

17. The computer program product of claim 14, wherein the bit representing the VCR function differs according to a VCR function supported by the source device.

18. The computer program product of claim 14, wherein the bit representing RAP information is used for a clip conversion.

19. The computer program product of claim 14, wherein the bit representing the contents ID includes information on contents desired by the user.

20. The computer program product of claim 14, wherein the bit representing the device ID indicates an ID of a sink device and the ID is used for authenticating the sink device.

21. A VOD system reconstruction method comprising:
measuring an access frequency of an object and an access frequency of service blocks;
comparing disk bandwidth wasted under current conditions with disk bandwidth consumed during system reconstruction; and
reconstructing the system based on the comparing results and the measured access frequency of the object and measured access frequency of the service blocks.

22. The VOD system reconstruction method of claim 21, wherein the reconstructing the system comprises:
establishing an access frequency of an object and an access frequency of the service blocks as an initial value input during an initial stage;
comparing the measured access frequency of the object and the measured access frequency of the service blocks with the established access frequencies to determine whether the access frequency has changed, if it is determined that the access frequency proceeding to the comparing disk bandwidth wasted under current conditions with disk bandwidth consumed during system reconstruction.

23. The VOD system reconstruction method of claim 21, wherein the reconstructing is triggered by inputting a new instance.

24. The VOD system reconstruction method of claim 21, further comprising:
authenticating requests for the objects and service blocks, wherein the access frequency of the objects and the access frequency of the service blocks are based on the requests.

25. A selective replication method comprising:
measuring an access frequency of an object and an access frequency of service blocks; and
replicating a number of objects and service blocks based on the measuring.
